(19) United States
(12) Patent Application Publication
(10) Pub. No.: US 2024/0067884 A1
(43) Pub. Date: Feb. 29, 2024

(54) Methods and Systems for Cracking Hydrocarbons

(71) Applicant: EXXONMOBIL CHEMICAL PATENTS INC., Baytown, TX (US)

(72) Inventors: Mark A. Rooney, Pasadena, TX (US); David K. Marsh, Houston, TX (US); Richard Young, Houston, TX (US); David Spicer, Houston, TX (US); William A. Aslaner, League City, TX (US); Jie Yang, Katy, TX (US)

(21) Appl. No.: 18/270,159

(22) PCT Filed: Jan. 5, 2022
(86) PCT No.: PCT/US2022/011212

§ 371 Date: Jun. 28, 2023

Related U.S. Application Data
(60) Provisional application No. 63/138,694, filed on Jan. 18, 2021.

(30) Foreign Application Priority Data
Mar. 8, 2021 (EP) 21161157.9

(51) Int. Cl. C10G 9/20; B01J 19/00; B01J 19/18; C10G 9/36

(52) U.S. Cl. CPC C10G 9/206; B01J 19/0013; B01J 19/1831; C10G 9/36; B01J 2219/00058; B01J 2219/00159; C10G 2300/708; C10G 2300/807

(57) ABSTRACT

The present disclosure relates to processes, methods, systems, and apparatus for steam cracking hydrocarbon in a pyrolysis furnace having a convection zone and a radiant zone. The convection zone includes three heat exchangers in series with a serpentine arrangement. A fluid source is disposed each heat exchanger to provide steam into the heat exchangers. The present disclosure further relates to a process of adjusting the stream flow rate for each fluid source to control operating conditions such as flue gas temperature, stack temperatures, and temperatures of other components of the furnace.

### CROSS-REFERENCE TO RELATED APPLICATIONS

This application claims priority to and the benefit of U.S. Provisional Application No. 63/138,694 having a filing date of Jan. 18, 2021, and European Patent Application No. 21161157.9 having a filing date of Mar. 8, 2021, the disclosures of all of which are incorporated herein by reference in their entireties.

### FIELD

The present disclosure generally relates to processes, methods, apparatus, and systems for cracking hydrocarbons.

### BACKGROUND

Steam cracking, referred to as pyrolysis, is used to crack various hydrocarbon feedstocks into olefins, such as ethylene, propylene, and butenes. Conventional steam cracking uses a pyrolysis furnace which has two main sections: a convection section and a radiant section. The hydrocarbon feedstock can enter the convection section of the furnace as a liquid. The feedstock can be heated and vaporized by indirect contact with hot flue gas from the radiant section and by direct contact with steam. The vaporized feedstock and steam mixture is then introduced into the radiant section where the cracking takes place. The resulting products including olefins leave the pyrolysis furnace for further downstream processing, including quenching.

Conventional steam cracking systems have been effective for cracking high-quality feedstocks which contain a large fraction of light volatile hydrocarbons, such as gas oil and naphtha. However, steam cracking economics sometimes favor cracking lower cost heavy feedstocks such as crude oil and atmospheric residue. Crude oil and atmospheric residue can contain high molecular weight, non-volatile components with boiling points in excess of 590° C. The non-volatile components of these feedstocks can promote coke accumulation in the convection section of pyrolysis furnaces. Only very low levels of non-volatile components can be tolerated in the convection section downstream of the point where the lighter components have fully vaporized. The term “coke” refers to heavy hydrocarbon liquid that is processed under gas cracking conditions, and is severely over-cracked forming “coke.”

To address coking issues, the feedstock can be preheated and then withdrawn from a preheater in the convection section of the pyrolysis furnace. This preheated feedstock can be mixed with steam and then introduced into a gas-liquid separator to separate and remove a portion of the non-volatiles as liquid from the separator. The separated vapor from the gas-liquid separator can be returned to the pyrolysis furnace for heating and cracking. However, managing coking using separators can impose constraints on convection temperatures. To manage convection temperatures, water can be injected into the super high pressure convection system. However, injecting too much water can result in mechanical reliability issues if outlet temperatures approach saturation temperatures (e.g., steam begins to form liquid droplets). Other processes that reduce the amount of water injected increase the stack temperature of the furnace which is undesirable for efficiency and sustainability considerations.

Thus, there is a need to provide flexible, sustainable, and efficient methods and systems for cracking hydrocarbons.

### SUMMARY

The present disclosure generally relates to an apparatus having a convection zone and a radiant zone. The convection zone has a first heat exchanger in fluid communication with a first section of a line. The first fluid source is coupled with the first section of the line downstream of the first exchanger. A second heat exchanger is in fluid communication with the first section of the line downstream of the first fluid source, the second heat exchanger is in fluid communication with a second section of the line downstream of the first section of the line. The apparatus includes a second fluid source coupled with the second section of the line downstream of the second heat exchanger. The second fluid source is coupled with the second section of the line downstream of the second heat exchanger. A third heat exchanger is in fluid communication with the second section of the line downstream of the second fluid source.

In some embodiments of the present disclosure, an apparatus is provided comprising a convection zone and a radiant zone. The convection zone includes a first heat exchanger coupled with a first line. A first fluid source is coupled with the first line downstream of the first heat exchanger. The apparatus includes a second line and a second heat exchanger coupled with the first line downstream of the first fluid source and coupled with the second line. The apparatus includes a second fluid source coupled with the second line downstream of the second heat exchanger and a third heat exchanger coupled with the second line downstream of the second fluid source.

In some embodiments of the present disclosure, a process for controlling a convection zone for a furnace is provided. The process includes heat exchanging steam with flue gas to provide heated steam and injecting water through a first fluid source to the heated steam to provide a first reduced temperature steam. The process includes heat exchanging the first reduced temperature stream with flue gas to provide an intermediate steam and injecting water through a second fluid source to the intermediate steam to provide a second reduced temperature steam. The process includes heat exchanging the second reduced temperature steam with flue gas at an export temperature suitable for export to a header to provide an export steam.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 depicts an apparatus in accordance with the present disclosure.

FIG. 2 depicts an example superheater convection section of a furnace in accordance with the present disclosure.

FIG. 3 depicts a flow diagram of an example method for processing hydrocarbons in accordance with the present disclosure.

To facilitate understanding, identical reference numerals have been used, where possible, to designate identical elements that are common to the figures. It is contemplated that elements and features of one example may be beneficially incorporated in other examples without further recitation.

### DETAILED DESCRIPTION

The present disclosure provides methods and systems for flexible, sustainable, and efficient cracking of hydrocarbons. In particular, the present disclosure provides methods and systems for managing temperature constraints of steam cracking furnaces. The hydrocarbon pyrolysis reactor (or furnace) used in the present disclosure comprises a convection section having at least one convection zone, and a radiant section. As used herein, a convection section can be described as the portion of the furnace where a feedstock can be treated by convection heating. For example, convection heating, as used herein, can be the indirect heat exchange of hot flue gas from the radiant section, in passages having heat conducting surfaces, such as a bank of metal tubes. The convection section can include one or more convection zones, each zone having an inlet to and an outlet from the convection section. A convection section can include one or more heating zones, as well as a preheating zone which preheats feedstocks in a heat exchanger using heated bottoms from a vapor liquid separator. Each convection zone can be associated with a tube bank for effecting heat exchange.

Saturated steam taken from a steam drum can be superheated in a high pressure steam superheater bank. The term “superheat” refers to heating a vapor steam under pressure above the steam's condensation point to provide a temperature above saturation or condensation. By way of example, at atmospheric pressure, water can be heated to about 100° C., then boiled to produce saturated steam, the saturated steam can be further heated to about 200° C. to produce superheated steam. It has been found that superheated steam is useful in the processes described herein because it does not immediately condense as it passes through cold piping or equipment. In some embodiments, for high pressure steam applications that supply power (e.g., ethylene plant or power plant), the water can be heated from about 120° C. supply at a pressure greater than 10 MPa to about 300° C. for boiling and then the saturated vapor is sent through a superheater heat exchanger to provide the additional superheat to the vapor. To achieve a desired turbine inlet steam temperature at all furnace operating conditions, two or more fluid sources can be injected in the high pressure steam superheater bank. The fluid sources can alternate between multiple heat exchangers arranged in series. The superheater outlet temperature can be controlled at a substantially constant temperature, independent of furnace load changes, coking extent changes, excess oxygen level changes, and/or other variables. This superheater can maintain the temperature of the high pressure steam at about 300° C. or greater, such as about 370° C. to about 590° C., such as about 425° C. to about 590° C. and/or gauge pressures at about 4 MPa to about 12 MPa, such as about 6 MPa to about 10 MPa, such as about 7 MPa to about 9 MPa to provide a reliable amount of superheat for the steam exceeding about 50° C. The fluid sources can inject water into some parts of the system through flow control valve(s) and water atomizer nozzle(s). After heating, the high pressure steam can exit the convection section and a fine mist of water can be added and rapidly vaporized to reduce the steam temperature in the convection section. The high pressure steam can return to the convection section to be further heated and exit for other uses in the production facility (e.g., ethylene production facility). The amount of water added to the superheater can control the temperature of the steam. In some embodiments, the water added to the superheater can maintain a stack temperature below about 150° C.

To enhance the ability to control coking of the feed stock streams in the tube bank, the high pressure steam superheater can be located in the convection section. Since the superheater is located within the furnace flue/convection section, it can act to superheat steam for running other process and steam turbines, and also to quench the furnace flue gas, as needed.

The terms “convert,” “converting,” “crack,” and “cracking” are defined broadly herein to include any suitable molecular decomposition, breaking apart, conversion, dehydrogenation, and/or reformation of hydrocarbon or other organic molecules, by means of at least pyrolysis heat, and can optionally include supplementation by one or more processes of catalysis, hydrogenation, diluents, stripping agents, and/or related processes.

Hydrocarbon feedstocks that can be processed using the methods and systems described herein can include recycle gas such as ethane, steam cracked oil/residue admixtures, gas oils, heating oil, jet fuel, diesel, kerosene, gasoline, coker naphtha, steam cracked naphtha, catalytically cracked naphtha, hydrocrackate, reformate, raffinate reformate, Fischer-Tropsch liquids, Fischer-Tropsch gases, natural gasoline, distillate, crude oil such as heavy crude oil, light virgin naphtha (LVN), atmospheric pipestill bottoms, vacuum pipestill streams including bottoms, wide boiling range naphtha to gas oil condensates, heavy non-virgin hydrocarbon streams from refineries, vacuum gas oils, heavy gas oil, naphtha contaminated with crude, atmospheric residue, heavy residue, hydrocarbon gas/residue admixtures, hydrogen/residue admixtures, liquid petroleum gas (LPG), and mixtures thereof.

Unless otherwise stated, all percentages, parts, ratios, etc., are by weight. Unless otherwise stated, a reference to a compound or component includes the compound or component by itself, and/or the compound or component in combination with other compounds or components, such as mixtures of compounds. Further, when an amount, concentration, or other value or parameter is given as a list of upper values and lower values, this is to be understood as specifically disclosing all ranges formed from any pair of an upper value and a lower value, regardless of whether ranges are separately disclosed.

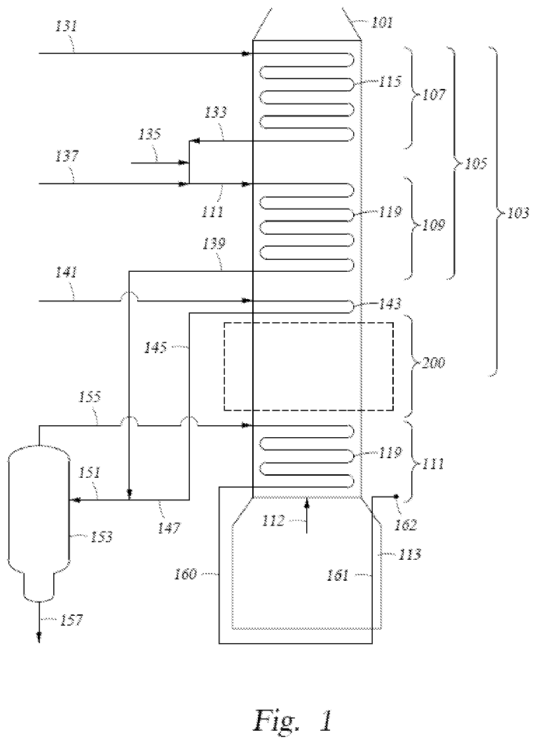

FIG. 1 depicts an apparatus in accordance with some aspects of the present disclosure. The heating of the hydrocarbon feedstock 131, can take any suitable form available in the art, such as heating by indirect contact of the hydrocarbon feedstock in a convection section 103 of a furnace 101 as shown in FIG. 1. The convection section 103 can include a first preheating zone 105 with a first and second bank of convection tubes 115, 117. The first bank of convection tubes 115 can be disposed at a first pre-heating section 107 of the first pre-heating zone 105 and the second bank of convection tubes 117 can be disposed substantially adjacent the first bank of convection tubes 115 at a second pre-heating section 109 of the first preheating zone 105. The hydrocarbon feedstock disposed within line 131 can be fed into the first bank of convection tubes 115 and heated by convection with hot flue gases of line 112 from the radiant section 113 that passes through the convection section 103 over each bank of convection tubes (e.g., 115, 117). The hydrocarbon feedstock of line 131 at the inlet of the first bank of convection tubes 115 can have a temperature of about 20° C. to about 300° C., such as about 25° C. to about 250° C., such as about 25° C. to about 100° C., such as about 32° C. to about 65° C., or 150° C. to about 250° C. (e.g., in some crude applications), and/or a pressure of about 790 kPa to about 1825 kPa, such as about 800 kPa to about 1800 kPa, such as about 800 kPa to about 1000 kPa, or about 1000 kPa to about 1800 kPa.

As will be understood by those skilled in the art, in commercial operations, one or more (e.g., each) of the tube banks can have multiple, parallel-flow systems of tubes, not merely a single tube within the furnace, e.g., as described in U.S. Pat. No. 3,365,387, which is incorporated herein by reference. Thus, any one or more than one flow path can be isolated by appropriate valving, thereby permitting a decoking cycle to be run on one or more selected off-stream tubing flow-paths, without disturbing the overall hydrocarbon pyrolysis process in the remaining on-stream tubes. Individual banks of tubes can be isolated, as disclosed in U.S. Pat. No. 8,864,977, which is incorporated herein by reference.

The heated hydrocarbon feedstock of line 133 can be mixed with primary dilution steam of line 137 and/or a fluid of line 135 such as a water. The fluid can be vapor, steam, liquid, or a mixture thereof. The mixing of the heated hydrocarbon feedstock and the primary dilution steam of line 137 and/or fluid of line 135 can occur inside or outside of the pyrolysis furnace 101, such as outside the pyrolysis furnace 101 using any mixing device known within the art such as a double sparger assembly. The fluid of line 135 can enter a first sparger of the double sparger assembly, which can avoid or reduce hammering caused by sudden vaporization of the fluid, upon introduction of the fluid into the heated hydrocarbon feedstock.

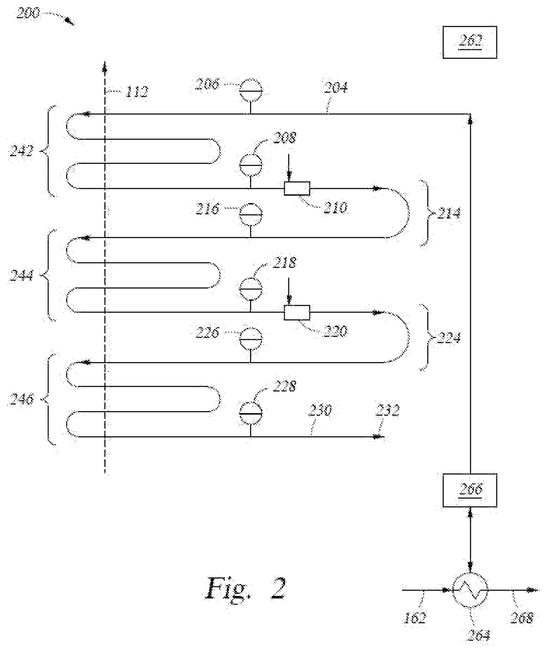

A secondary dilution steam of line 141 can be heated in a first superheater tube bank 143 to produce a second separator feed 147. The source of the secondary dilution steam can be primary dilution steam that has been superheated, such as in the convection section 103 of the pyrolysis furnace 101. Either or both of the primary and secondary dilution steam streams can include sour or process steam. Superheating the sour or process dilution steam can minimize the risk of corrosion from condensation of sour or process steam. The primary dilution steam of line 137 can be injected into a second sparger of the double sparger assembly, and the resulting stream mixture of line 136 can enter the second bank of convection tubes 117 for additional heating with flue gas (represented by arrow 112) to produce a first separator feed 139. The first separator feed 139 can be mixed with the second separator feed 147 and introduced to a flash/liquid separator vessel 153 to produce two phases, including a vapor phase of line 155 and a liquid phase of line 157. The vapor phase of line 155 can include volatile hydrocarbons and steam. The liquid phase of line 157 can include non-volatile hydrocarbons, including coke precursors. The vapor phase can be fed to a lower convection section tube bank 119 in a second preheating zone 111 of the convection section 103. The second preheating zone 111 can be proximate to the radiant section 113 of the furnace, and the vapor phase can pass through crossover pipes 160 to the radiant section of the pyrolysis furnace for cracking into a radiant section effluent of line 162. The radiant section effluent of line 162 can be rapidly cooled in a transfer-line exchanger (“TLE”) 264, generating saturated steam of line 204 in a thermosyphon arrangement with steel drum 266, as shown in FIG. 2. The saturated steam of line 204 generated from the drum can be superheated in the superheater convection section 200, which is further described herein in reference to FIG. 2. The steam of TLE 264 generated in the TLE can be used to drive large steam turbines.

FIG. 2 depicts an example superheater convection section 200 of a furnace 101 in accordance with the present disclosure. The superheater convection section 200 of the furnace 101 can be disposed above the second preheating zone 111 and below the first superheater tube bank 143. The superheater section 200 can include a series of alternating heat exchangers (e.g., first, second, and third heat exchangers 242, 244, 246) and desuperheaters (e.g., fluid injection points 210, 220). The multiple desuperheaters alternating between heat exchangers enable control of steam conditions along the superheater convection section, stack temperatures, and flue gas temperatures for multiple feeds and at various conditions such as decoking mode and cracking mode. In some embodiments, flue gas rates and steam rates through the convection section are monitored to control process parameters, such as steam outlet temperature. As used herein, the term “desuperheater” refers to a device used for reducing the temperature of steam to a less superheated temperature.

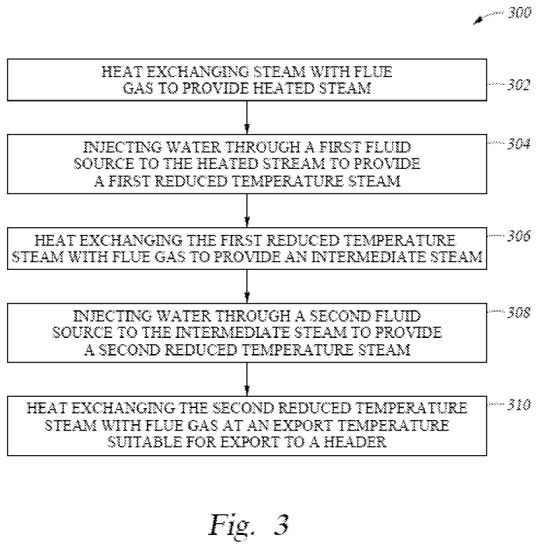

FIG. 3 depicts a flow diagram of an example method 300 for processing hydrocarbons in accordance with some aspects of the present disclosure. The method 300 can include:
heating steam, such as a light hydrocarbon feedstock, in a convection section of a pyrolysis furnace with hot flue gas from a radiant section of the pyrolysis furnace to provide heated steam at operation 302;
injecting water through a first fluid source to the heated steam to provide a first reduced temperature steam at operation 304;
heating the first reduced temperature steam with the flue gas to provide an intermediate steam at operation 306;
injecting water through a second fluid source to the intermediate steam to provide a second reduced temperature steam at operation 308; and
heating the second reduced temperature steam with hot flue gas at an export temperature suitable for export to a header at operation 310.

Referring back to FIG. 2, heating steam (e.g., operation 302) with flue gas 112 can occur in a first heat exchanger 242 of the superheater convection section 200. In some embodiments, the first, second and third heat exchangers 242, 244, 246 can be arranged in a serpentine arrangement, such parallel-flow systems of tubes or a single continuous tube. The tubes can be made from any suitable metal such as low chromium steel or stainless steel. Low chromium steel can include about 1.25 wt % to about 9 wt %, such as 1.2 wt % to about 7 wt %, or about 2 wt % to about 5 wt % chromium by weight of total metal in the tube. The steam (e.g., saturated steam) can be a saturated steam at about 260° C. or greater, such as about 300° C. to about 374° C., such as about 310° C. to about 360° C., such as about 320° C. to about 340, such as about 328° C. and/or at about 3 MPa to about 20 MPa, such as about 4 MPa to about 12 MPa. The maximum temperature can be determined by the critical temperature of the steam. In some embodiments, a feed temperature sensor 206 can be coupled to the feed line 204 to monitor the temperature of the steam (e.g., saturated steam). The steam can enter at a feed section or feed line 204 and be heated in the first heat exchanger 242 to provide a heated steam. The steam can be heated at least above the saturation temperature of the steam, such as above 300° C., or above 328° C. The steam can be heated at least 10° C. above the saturation temperature of the steam, such as 10° C. to about 20° C. above saturation temperature, or 10° C. to about 30° C., alternatively at least about 20° C. above saturation temperature, such as at least about 30° C. above saturation temperature, such as at least about 40° C. above saturation temperature, such as 50° C. above saturation temperature, such as about 100° C. to about 150° C. above saturation temperature. The steam can be heated at temperatures below the design temperature of the heat exchange tubing, such as less than about 850° C., such as less than about 650° C., such as less than about 525° C., such as less than about 500° C., such as less than about 450° C. The first heat exchanger 242 can be in fluid communication with a first line or first section of a line 214. In some embodiments, a first temperature sensor 208 can be coupled to the first line 214 downstream of the first heat exchanger 242 to monitor the temperature of the heated steam. As used herein, unless otherwise stated, the term “downstream” with reference to superheater convection section 200 refers to a steam flow direction from steal drum 266 to the exit line 230. In some embodiments, the heat exchange tubing is composed of 1.25 Cr steel or less than 1.25 Cr steel.

The method 300 can include injecting water through a first fluid source to the heated steam to provide a first reduced temperature steam (e.g., operation 304). A first fluid source 210 can be coupled with the first line 214 downstream of the first temperature sensor 208. The first fluid source 210 (e.g., desuperheater) can be a control valve and can include a water atomizer nozzle. The water can be injected at the first fluid source 210 as a fine mist that vaporizes and reduces the temperature of the heated steam. In some embodiments, the first reduced temperature steam can be temperature controlled by adjusting flow rate from the first fluid source 210. For example, fluid source 210 and first temperature sensor 208 can be communicatively coupled to a control module 262. The flow rate of the fluid injected into the system can be 0 tph if the temperature of the first temperature sensor 208 is below a predetermined operating parameter such as a max temperature of from about 60° C. to about 80° C., such as about 70° C. to about 75° C. above saturation temperature. The flow rate of the fluid injected into the system can be greater than 0 tph if the first temperature sensor 208 reading is at or above a predetermined operating parameter. In some embodiments, the flow rate of fluid from the first fluid source can be from 0 to about 9 tph, such as from 0 to about 5 tph, such as from 1 tph to about 4 tph. The weight percentage of inlet steam flow rate based on a total fluid flow rate from the first fluid source is about 0 wt % to about 15 wt %, such as from about 1 wt % to about 5 wt %, such as about 1 wt % to about 3 wt %, such as about 1.5 wt % or alternatively from about 7 wt % to about 15 wt %, such as about 9 wt % to about 13 wt %. In some embodiments, the first reduced temperature steam can be monitored by a second temperature sensor 216 that can be coupled to the first line 214. The second temperature sensor 216 can be communicatively coupled to the control module 262. The first fluid source can include a first control valve that is also communicatively coupled to the control module 262 to control flow rate through the first control valve based on the second temperature sensor 216 data, such as based on the differential temperature between the first and second temperature sensor 206, 208.

The first reduced temperature steam can be heated with the flue gas 112 to provide an intermediate steam (e.g., operation 306). The first reduced temperature steam can be heated in a second heat exchanger 244. The second heat exchanger 244 can be in fluid communication with a second line or second section of the line 224 downstream of the first line 214. The second fluid source 220 can be coupled with the second line 224 downstream of the second heat exchanger 244. In some embodiments, the intermediate steam can be monitored by a third temperature sensor 218 that can be coupled to the second line 224. The third temperature sensor 218 can be communicatively coupled to the control module 262.

A second fluid source 220 can inject fluid to the intermediate steam to provide a second reduced temperature steam (e.g., operation 308). The second fluid source can include a second control valve that is communicatively coupled to the control module 262 to control flow rate through the second control valve based on the third temperature sensor 218 data. The flow rate of the fluid injected into the system can be 0 tph (e.g., the process is free of flow of the fluid) if the temperature of the third temperature sensor 218 is below a predetermined operating parameter such as a max temperature of from about 60° C. to about 80° C., such as about 70° C. to about 75° C. above saturation temperature. The flow rate of the fluid injected into the system can be greater than 0 tph if the third temperature sensor 218 reading is at or above a predetermined operating parameter. In some embodiments, the flow rate of fluid from the second fluid source can be 0 tph, or can be from 0.1 to about 9 tph, such as from 0.5 to 7 tph, such as from 1 tph to 6 tph. The weight percentage of inlet steam flow based on a total fluid flow rate from the first fluid source is about 0 wt % to about 20 wt %, such as from about 1 wt % to about 5 wt %, such as about 1 wt % to about 3 wt %, such as about 1.5 wt % or alternatively from about 7 wt % to about 18 wt %, such as about 12 wt % to about 17 wt %. In some embodiments, the first control valve can be in a closed position and the second control valve can be controlled to adjust steam temperature. In some embodiments, the first control valve can be open once the second control valve is completely open and the steam temperature is above the predetermined max temperature. In some embodiments, the first and second control valves can be adjusted simultaneously.

A fourth temperature sensor 226 can be coupled to the second line 224 downstream of the second fluid source 220. The fourth temperature sensor 226 can be communicatively coupled to the control module 262. The flow rate through the second control valve can be controlled based on the fourth temperature sensor 226 data, such as based on the differential temperature between the third and fourth temperature sensor 218, 226.

The second reduced temperature steam can be heated with hot flue gas at an export temperature suitable for export to a header (e.g., operation 310). The second reduced temperature steam can be heated by a third heat exchanger 246 disposed in fluid communication with the second section of the line 224 downstream of the second fluid source 220 and downstream of the fourth temperature sensor 226. In some embodiments, the export temperature can be monitored by an export temperature sensor 228 that can be coupled to an export section of the line or an export line 230. The export temperature sensor 228 can be communicatively coupled to the control module 262. In some embodiments, the steam export temperature reading on the export temperature sensor 228 and the temperatures just downstream of the water injections shown in the readings of the second and fourth temperature sensors (e.g. 216, 226) are controlled by adding more water at first and second flow control valves 210, 220. The export temperature can be a superheated temperature of the steam.

The three or more heat exchangers in series with two or more water injection points as described herein are arranged such that the heat exchangers convey steam flow in a countercurrent orientation when compared to the flue gas flow. It has been found that this arrangement allows the use of the second fluid source 220 to cool the third heat exchanger 246, and therefore cool the flue gas 112 exiting the third heat exchanger 246. Moreover, the duty on the first and second heat exchangers are reduced which reduces the temperature of steam entering the first and second fluid sources downstream of each of the first and second heat exchangers 242, 244. In effect, cooling the upstream flue gas reduces the steam outlet temperature of the first and second heat exchangers. This can be implemented by a high temperature override that increases water flow when a flue gas temperature downstream of the superheaters reaches a predetermined temperature.

In some embodiments, the stack temperature can be maintained from about 90° C. to about 150° C. The multiple fluid sources as described herein enables running a process at higher flue gas rates to increase the stack temperature above a predetermined minimum or at lower flue gas rates to reduce the stack temperature below a predetermined maximum. The multiple fluid sources provides an additional way to manage stack temperature with respect to other potential constraints, such as each of the sections disposed downstream of the superheater convection section 200 (e.g., downstream relative to the flue gas direction) such as one or more of an selective catalytic reduction (SCR) bed 170, an ammonia injection grid (AIG) 172, the first separator feed 139, the second separator feed 147, and the vapor phase stream 160. In some embodiments, the flue gas 112 can be cooled in the superheater convection section 200 by adjusting the first and/or second fluid sources. The cooled flue gas 112 exiting the superheater convection section 200, can reduce the temperature of each of the sections disposed downstream of the superheater section 200 (e.g., downstream relative to flue gas direction). For example, the temperature of the first pre-heating zone 105 can be reduced and can reduce the temperature of the first and second bank of convection tubes 115, 117. The first and second bank of convection tubes 115, 117 can be reduced due to reduced heatexchange from the flue gas 112 and can reduce the temperature of the other sections and streams.

### Decoking and Cracking Operations

The systems and methods described herein provide the flexibility of running a furnace (e.g., furnace 101) during normal cracking operations as well as during decoking operations. During the cracking operation, various internal contact surfaces of the pyrolysis furnace can accumulate “coke” such as in the radiant section 161. Coke can be removed in a decoking operation, where the decoking operation can include operating parameters for individual tube banks such as the superheater convection section 200, to allow decoking of the radiant section 161. The decoking operation can include running the furnace and allowing TLE steam to generate in the TLE 264 while cooling the flue gas 112. In a split operation referred to herein as “on-stream decoking,” a portion of the furnace, such as a thermal cracking tube, can be isolated and decoked while other portions continue to operate in cracking mode.

The cracking mode can have a first set of operating conditions including flue gas rates, TLE flow rates, and steam temperatures. In some embodiments, the first set of points include flue gas flow rate of about 150 tph to about 350 tph, such as from about 200 tph to about 300 tph, such as about 250 tph.

The decoking mode can have a second set of points including flue gas rates, TLE flow rates, and steam temperatures. In some embodiments, the second set of operating conditions for decoking mode includes flue gas flow rate of about 40 tph to about 60 tph, such as about 45 tph to about 55 tph, such as about 50 tph. In some embodiments, the second set of operating conditions can also be used for steam standby mode. Steam standby mode refers to a transition to and from decoking and as a standby condition that can be maintained for hours to days and readily changed to decoking or cracking mode. As modes change, the operating conditions change and are managed by adjusting controls to keep temperatures within the rest of the furnace components within range. In particular, the temperature is managed for one or more of the stack temperature, SCR inlet temperature, AIG inlet temperature, separator 153 inlet temperature, first separator feed 139 temperature, vapor phase stream 160 temperature, superheated steam temperatures (e.g., 208, 216, 218, 226, and 228), and water and steam rates (e.g., 135, 137).

The weight ratio of flue gas rates from cracking mode to decoking mode can be from about 2:1 to about 7:1, such as about 4:1 to about 6:1, such as about 5:1. In some embodiments, three different operation modes include: 1) a high superheated steam flow rate with low duty cracking mode (e.g., for cracking recycle gas such as ethane) having saturated steam feed rates of about 66 tph; 2) a low superheated steam flow rate with high duty cracking mode (e.g., for cracking crude) having saturated steam feed rates of about 20 to about 40 tph; and 3) a very low saturated steam flow rate and high comparative flue gas flow rate decoking mode having saturated steam feed rates of about 40 tph to about 50 tph, such as about 48 tph. Operation mode 1 (e.g., cracking recycle gas) can have an inlet flue gas temperature of about 700° C. to about 1100° C., such as about 800° C. to about 1000° C., such as about 900° C. Operation mode 2 (e.g., cracking crude) can have an inlet flue gas temperature of about 675° C. to about 1075° C., such as about 775° C. to about 975° C., such as about 877° C. Operation mode 1 and 2 are both cracking modes. In some embodiments, operation mode 1 can have inlet flue gas temperatures about 5° C. to about 40° C., such as about 10° C. to about 30° C., such as about 23° C. higher than the inlet flue gas temperatures of operation mode 2. In some embodiments, operation mode 1 can have flue gas flow rates about 1% to about 5%, such as about 2% to about 4%, such as about 3% higher than operation mode 2 and operation mode 1 can have saturated steam feed rates that are about 1.5 to about 2.5, such as about 2.2 times greater than operation mode 2. Increasing the temperature of the flue gas can improve flexibility for decoking operations in which decoking operating (e.g., operation mode 3) can have a flue gas temperature about 150° C. to about 200° C. different from the cracking modes and a ratio of the flue gas flow to process flow can be substantially different from the cracking operation. The ratio of flue gas flow to process flow can affect heat transfer and result in slower cooling of the flue gas and hotter temperatures of furnace components downstream of the superheater convection section (e.g., downstream relative to flue gas flow).

The weight ratio by weight of total water flow rate of the maximum of any cracking mode or decoking mode to the minimum of any cracking mode or decoking mode can be from about 2:1 to about 15:1, such as from 5:1 to about 12:1, such as from 8:1 to about 11:1, such as about 10:1.

A steam flow ratio of the cracking stream flow rate to decoking steam flow rate can be about 1.25:1 to about 2.25:1, such as about 1.5:1 to about 2:1.

It has also been contemplated that methods described herein can be performed by a programed system having an algorithm stored in a memory of the system. The algorithm can include a number of instructions which, when executed by a processor, can cause the method described herein to be performed.

### Example

The systems and methods described herein provide the flexibility of running the furnace 101 for a wide variety of feedstocks and operating parameters for each feedstock. A comparative superheater convection section was arranged with two heat exchangers and a single fluid source coupled to a line disposed between the two heat exchangers. The comparative superheater convection section was used to process a recycled ethane gas feedstock and a crude oil feedstock. The processing parameters for each case is summarized in Table 1. In each case, the water temperature provided at the fluid source was 121° C., the saturation temperature of the steam was 328° C., and the superheated steam temperature was 525° C. The design temperature of the tubing for each of the convection systems ranged from 505° C. to 560° C.

TABLE 1
Comparative Superheater Convection System

| | | |
|---|---|---|
| Feedstock | Recycled Gas | Crude Oil |

| | | | | |
|---|---|---|---|---|
| Inlet Steam Flow | 66 | tph | 30 | tph |
| Water flow at Fluid Source | 0.9 | tph | 7 | tph |
| First Section Duty | 6.1 | MW | 5.1 | MW |
| Second Section Duty | 8.1 | MW | 6.8 | MW |
| Feed Temperature | 328° | C. | 328° | C. |
| First Temperature Sensor | 404° | C. | 487° | C. |
| Second Temperature Sensor | 394° | C. | 328° | C. |
| Export Temperature | 525° | C. | 525° | C. |

The first and second sections can be described as first and second heat exchangers that convectively heat steam within the tubing with the countercurrent flow of flue gas from the radiant section of the furnace. The duty delivered in each of the first and second heat exchangers was 6.1 MW/8.1 MW for recycled gas and 5.1 MW/6.8 MW for crude oil. The feed temperature into the first heat exchanger was estimated to be the saturation temperature of the steam. A first temperature sensor was coupled to a line downstream of the first heat exchanger and upstream of the fluid source relative to the flow of the steam. A second temperature sensor was coupled to the line downstream of the fluid source and upstream of the second heat exchanger. As can be seen in Table 1, for the crude feedstock, the temperature at the second temperature sensor is below the saturation temperature of the steam. Thus, the steam at least partially condensed resulting in potential water and mechanical damage.

An example superheater convection system in accordance to the present disclosure is provided in Table 2. As can be seen, less water was needed at each of the first and second fluid sources for each of the feedstock cases. The duty delivered at each of the first, second, and third sections (e.g., heat exchangers) was lower than the Comparative (e.g., Table 1). Moreover, each of the temperatures were maintained above saturation temperature and below the design temperature of the tubing. Finally, the export temperature equal to the superheated temperature of the steam (e.g., 525° C.) was achieved.

TABLE 2
Example Superheater Convection System

| Feedstock | Recycled Gas (Ethane) | | Crude Oil | |
|---|---|---|---|---|
| Inlet steam flow | 66 | tph | 30 | tph |
| Water flow at First Fluid | 0 | tph | 3 | tph |
| Source | | | | |
| Water flow at Second Fluid | 0.9 | tph | 5 | tph |
| Source | | | | |
| First Section Duty | 6.3 | MW | 5.0 | MW |
| Second Section Duty | 3.9 | MW | 3.1 | MW |
| Third Section Duty | 4.0 | MW | 3.7 | MW |
| Feed Temperature | 328° | C. | 328° | C. |
| First Temperature Sensor | 395° | C. | 480° | C. |
| Second Temperature Sensor | 395° | C. | 406° | C. |
| Third Temperature Sensor | 461° | C. | 526° | C. |
| Fourth Temperature Sensor | 449° | C. | 402° | C. |
| Export Temperature | 525° | C. | 525° | C. |

Three operating conditions were compared to study the flue gas temperature differences, flue gas flow differences, and steam flow differences between operating conditions. The substantial differences between the operating conditions highlight challenges in furnace operating flexibility. The superheater convection section 200 as described herein addresses the large processing differences using the water injection arrangement described herein. The flue gas temperature entering the convection section for gas cracking mode was 15° C. less than the case of crude cracking mode. The flue gas temperature entering the convection section for gas cracking mode was 123° C. higher than the flue gas temperature entering SSH for decoking mode. The flue gas temperature going into the superheater convection section 200 for gas cracking mode was 22° C. higher than the flue gas temperature entering the convection section for decoking mode. The flue gas temperature going into the superheater convection section 200 for gas cracking mode was 54° C. higher than the flue gas temperature entering the superheater convection section 200 for decoking mode. The ratio of TLE steam generation of gas cracking mode to crude cracking mode was about 2.2:1. The ratio of TLE steam generation of gas cracking mode to decoking mode was about 1.6:1. The flue gas flow rate ratio of gas cracking mode to crude cracking mode was 1:1 and the flue gas flow rate ratio of gas cracking mode to decoking mode was 1.2:1.

All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

1. An apparatus comprising a convection zone and a radiant zone, the convection zone comprising:
a first heat exchanger in fluid communication with a first section of a line;
a first fluid source coupled with the first section of the line downstream of the first heat exchanger;
a second heat exchanger in fluid communication with the first section of the line downstream of the first fluid source, wherein the second heat exchanger is in fluid communication with a second section of the line downstream of the first section of the line;
a second fluid source coupled with the second section of the line downstream of the second heat exchanger; and
a third heat exchanger in fluid communication with the second section of the line downstream of the second fluid source.

2. The apparatus of claim 1, wherein the first fluid source comprises a first flow control valve and the second fluid source comprises a second flow control valve.

3. The apparatus of claim 2, further comprising a control module communicatively-coupled to the first flow control valve and the second flow control valve.

4. The apparatus of claim 1, further comprising:
a first temperature sensor coupled with the first section of the line between the first heat exchanger and the first fluid source;
a second temperature sensor coupled with the first section of the line between the first fluid source and the second heat exchanger;
a third temperature sensor coupled with the second section of the line between the second heat exchanger and the second fluid source; and
a fourth temperature sensor coupled with the second section of the line between the second fluid source and the third heat exchanger.

5. The apparatus of claim 4, further comprising:
a control module communicatively coupled to each temperature sensor and each of the first fluid source and the second fluid source.

6. The apparatus of claim 1, wherein the heat exchangers are metal tubes.

7. An apparatus comprising a convection zone and a radiant zone, the convection zone comprising:
a first heat exchanger coupled with a first line;
a first fluid source coupled with the first line downstream of the first heat exchanger;
a second line;
a second heat exchanger coupled with the first line downstream of the first fluid source and wherein the second heat exchanger is coupled with the second line;
a second fluid source coupled with the second line downstream of the second heat exchanger; and
a third heat exchanger coupled with the second line downstream of the second fluid source.

8. The apparatus of claim 7, further comprising:
a first temperature sensor coupled with the first line between the first heat exchanger and the first fluid source;
a second temperature sensor coupled with the first line between the first fluid source and the second heat exchanger;
a third temperature sensor coupled with the second line between the second heat exchanger and the second fluid source; and
a fourth temperature sensor coupled with the second line between the second fluid source and the third heat exchanger.

9. The apparatus of claim 8, further comprising:
an export temperature sensor coupled to an export line downstream of the third heat exchanger; and
a control module communicatively coupled to each temperature sensor and each of the first fluid source and the second fluid source.

10. The apparatus of claim 8, further comprising a control module communicatively coupled to each temperature sensor and each of the first fluid source and the second fluid source, wherein the first fluid source is a first flow control valve and the second fluid source is a second flow control valve.

11. A process for controlling a convection zone for a furnace, the process comprising:
heat exchanging steam with flue gas to provide heated steam;
injecting water through a first fluid source to the heated steam to provide a first reduced temperature steam;
heat exchanging the first reduced temperature stream with flue gas to provide an intermediate steam;
injecting water through a second fluid source to the intermediate steam to provide a second reduced temperature steam; and
heat exchanging the second reduced temperature steam with flue gas at an export temperature suitable for export to a header to provide an export steam.

12. The process of claim 11, wherein the first fluid source comprises a first flow control valve and the second fluid source comprises a second flow control valve.

13. The process of claim 12, wherein:
injecting water through the first fluid source comprises completely opening the first flow control valve, and
injecting water through the second fluid source comprises opening the second flow control valve after completely opening the first flow control valve.

14. The process of claim 12, further comprising opening the first flow control valve and the second flow concurrently.

15. The process of claim 11, further comprising:
measuring a first temperature of the heated steam with a first temperature sensor;
controlling a second temperature of the first reduced temperature steam by measuring the second temperature with a second temperature sensor and adjusting a first water flow rate of the first water fluid source;
measuring a third temperature of the intermediate steam with a third temperature sensor; and
controlling a fourth temperature of the second reduced temperature steam by measuring the second reduced temperature steam with a fourth temperature sensor and adjusting a second water flow rate of the second water fluid source.

16. The process of claim 15, wherein each of the first temperature and the third temperature is less than a design temperature of piping of the convection zone, and wherein each of the second temperature and fourth temperature is at least 50° C. above a saturation temperature of the steam.

17. The process of claim 15, further comprising managing a selective catalytic reduction system inlet temperature at about 310° C. to about 400° C. by adjusting the first water flow rate of the first water fluid source and adjusting the second water flow rate of the second water fluid source.

18. The process of claim 15, wherein each of the first temperature and the third temperature is less than about 525° C. and each of the second temperature and the fourth temperature is greater than at least 20° C. above a saturation temperature of the steam.

19. The process of claim 11, further comprising maintaining a stack temperature at least about 150° C. by adjusting a total water flow rate of the first and second water fluid source.

20. The process of claim 11, wherein the export temperature is a superheated temperature of the steam.

21. The process of claim 11, further comprising selecting an operating mode, the operating mode selected from the group consisting of a cracking mode, a decoking mode, and a combination thereof, the cracking mode composing a first set of operating conditions comprising a cracking steam flow rate and a second set of operating conditions comprising a decoking steam flow rate, wherein a steam flow ratio of the cracking stream flow rate to decoking steam flow rate is about 1.25:1 to about 2.25:1.

22. The process of claim 21, wherein selecting the operating mode, further comprises selecting a feedstock mode, the feedstock mode selected from the group consisting of ethane feed, crude, naphtha, gas oil feed, and a combination thereof, wherein selecting the feedstock mode determines an amount of water to inject to the first fluid source and the second fluid source.

23. The process claim 21, wherein the cracking mode further comprises a recycle gas cracking mode, a crude cracking mode, a liquid feed cracking mode, and a combination(s) thereof.

24. The process of claim 21, wherein the first set of operating conditions for the decoking mode further comprise a first total flow rate of water from the first fluid source and second fluid source, wherein the second set of operating conditions for the cracking mode further comprise a second total flow rate of water front the first fluid source and second fluid source, wherein a total flow rate ratio of the first total flow rate to the second total flow rate is about 5:1 to about 20:1.

25. A system programmed to perform a method, comprising:
an algorithm stored in a memory of the system, wherein the algorithm comprises a number of instructions which, when executed by a processor, causes a method to be performed, the method comprising:
heat exchanging steam with flue gas to provide heated steam;
injecting water through a first fluid source to provide a first reduced temperature steam;
heat exchanging the first reduced temperature steam with flue gas to provide an intermediate steam;
injecting water through a second fluid source to provide a second reduced temperature steam; and
heat exchanging the second reduced temperature steam with flue gas at an export temperature suitable for export to a header.
